(19) United States
(12) Patent Application Publication
(10) Pub. No.: US 2024/0104742 A1
(43) Pub. Date: Mar. 28, 2024

(54) IMAGE SEGMENTATION

(71) Applicants: HEWLETT-PACKARD DEVELOPMENT COMPANY, L.P., Spring, TX (US); PURDUE RESEARCH FOUNDATION, West Lafayette, IN (US)

(72) Inventors: Weichen XU, West Lafayette, IN (US); Yezhi SHEN, West Lafayette, IN (US); Qian LIN, Palo Alto, CA (US); Jan P. ALLEBACH, West Lafayette, IN (US); Fengqing ZHU, West Lafayette, IN (US)

(21) Appl. No.: 17/946,198

(22) Filed: Sep. 16, 2022

(51) Int. Cl. G06T 7/10; G06T 7/33; G06T 9/00

(52) U.S. Cl. CPC G06T 7/10; G06T 7/33; G06T 9/004

(57) ABSTRACT

In examples, an electronic device is provided. The electronic device includes a processor to receive an input image from an image sensor. The processor is also to scale a size of the input image to a programmed size. The processor is also to encode the scaled input image to provide a feature map having a fractional size of the scaled input image. The processor is also to process the feature map according to lite reduced atrous spatial pyramid pooling (LR-ASPP) to provide a LR-ASPP result. The processor is also to decode the LR-ASPP result to provide an image segmentation result.

### BACKGROUND

Electronic devices such as desktops, laptops, notebooks, tablets, and smartphones include executable code that enables users to perform video conferencing. During video conferencing sessions, video may be captured by a user's device and transmitted to a viewer's device in substantially real time (e.g., accounting for transmission lag but not having a delay to allow any meaningful amount of processing to be performed). Some video conferencing experiences enable the virtual modification of a user's background, either via blurring of the user's background or replacement of the user's background.

### BRIEF DESCRIPTION OF THE DRAWINGS

Various examples will be described below referring to the following figures:

FIG. 1 is a block diagram of an electronic device in accordance with various examples.

FIG. 2 is a diagram of a U-shaped encoder-decoder architecture, in accordance with various examples

FIG. 3 is a flow diagram of a method in accordance with various examples.

FIGS. 4 and 5 are block diagrams of an electronic device in accordance with various examples.

FIG. 6 is a block diagram of non-transitory, computer-readable media in accordance with various examples.

### DETAILED DESCRIPTION

As described above, electronic devices such as desktops, laptops, notebooks, tablets, and smartphones include executable code that enables users to perform video conferencing. During video conferencing sessions, video may be captured by a user's device and transmitted to a viewer's device in substantially real time (e.g., accounting for transmission lag but not having a delay to allow any meaningful amount of processing to be performed). Some video conferencing experiences enable the virtual modification of a user's background, either via blurring of the background or background replacement. Both background blurring and background replacement include separation of a foreground (e.g., the user) from a background of the video. Such separation of an image can be performed via processing of the image by a convolutional neural network (CNN). However, the use of a CNN may be computationally intensive, making at least some CNN-based approaches unsuitable, or have limited applicability, in low-power, or high-efficiency, application environments, such as mobile devices.

To mitigate and/or reduce the computational intensity of CNN-based image segmentation, a U-shaped encoder-decoder CNN architecture may be employed. The architecture provides for receiving an input image and resizing the input image to reduce the image size of the input image to a programmed size. Reducing the image size may reduce computational intensity of the image segmentation. Some amount of reduced accuracy in the image segmentation may also be associated with the reduced image size. For example, an accuracy of image segmentation for the image at its reduced image size may be less than an accuracy for the image at its originally received size.

Following the reduction in image size, the image is encoded to provide an output feature map that is a fractional size of the input image. The encoding may be a multi-stage encoding in which each stage decreases the size of the feature map with respect to a prior stage, and an output of each stage is available as an intermediate output of the encoding in addition to being provided to a next stage. In some examples, the encoding is performed via a CNN, or a partial CNN, such as MobileNetV3. In other examples, the encoding is provided by any suitable encoding process that provides an output feature map that is a fractional size of the input image and includes taps or outputs between stages of the CNN that facilitate the taking of intermediate outputs of the encoding.

The output feature map is provided to a bottleneck portion of the U-shaped CNN architecture (e.g., such as a transitional portion from encoder to decoder), such as a lite reduced atrous spatial pyramid pooling (LR-ASPP) module for processing in parallel paths. In a first path, the feature map undergoes a 1×1 convolution to reduce its size, is normalized via batch normalization, and then undergoes Rectified Linear Unit (ReLU) activation to introduce non-linearity to counter a linearity of the 1×1 convolution. In a second path, the feature map is processed according to global average pooling, undergoes a 1×1 convolution to reduce its size, and undergoes Sigmoid activation to normalize and weight the channels of the second path. The LR-ASPP module multiplies outputs of the first and second paths to provide a LR-ASPP output. The LR-ASPP output is decoded via a combination of bilinear up-sampling and processing via convolutional blocks until, as a final step in the image segmentation, a final convolution layer projects the feature map to an output size that is equal to a programmed image size, such as the reduced image size. The channel number of the final convolution layer is equal to the segmentation class number, which may have a value of 2 to represent the foreground and background of the input image. In at least some examples, such a U-shaped encoder-decoder architecture reduces computational intensity of image segmentation while maintaining similar image segmentation accuracy when compared to more computationally intensive CNN processes for segmentation to facilitate blurring a user's background or replacement of the user's background.

In examples, an electronic device is provided. The electronic device includes a processor to receive an input image from an image sensor. The processor is also to scale a size of the input image to a programmed size. The processor is also to encode the scaled input image to provide a feature map having a fractional size of the scaled input image. The processor is also to process the feature map according to LR-ASPP to provide a LR-ASPP result. The processor is also to decode the LR-ASPP result to provide an image segmentation result.

In examples, an electronic device is provided. The electronic device includes a processor to implement an image segmentation process. To implement the image segmentation process, the processor is to reduce a size of an input image to a programmed size. The processor also is to perform convolution to provide a feature map having a fractional size of the scaled input image. The processor also is to process the feature map according to LR-ASPP to provide a LR-ASPP result. The processor also is to perform bi-linear upsampling of the LR-ASPP result to provide an image segmentation result.

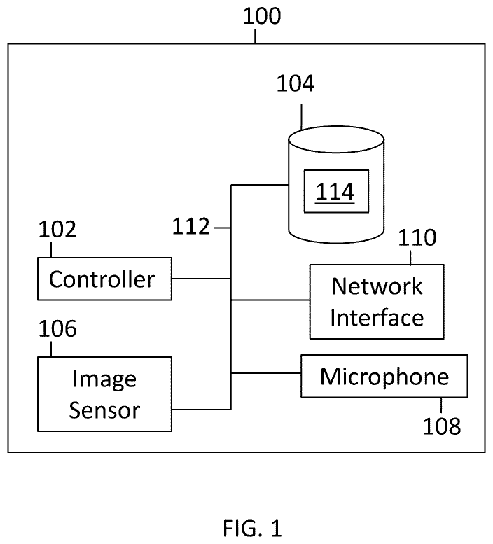

In examples, a non-transitory computer-readable medium storing machine-readable instructions is provided. When executed by a controller of an electronic device, the instructions cause the controller to receive an input image, scale a size of the input image to a programmed size, encode the scaled input image by down-sampling the scaled input image according to convolutional layers to provide a feature map having a fractional size of the scaled input image, process the feature map according to LR-ASPP to provide a LR-ASPP result, and decode the LR-ASPP result by performing bi-linear upsampling and convolution processing of the LR-ASPP result to provide an image segmentation result. FIG. 1 is a block diagram of an electronic device 100 in accordance with various examples. The electronic device 100 may be a laptop computer, a desktop computer, a notebook, a tablet, a server, a smartphone, or any other suitable electronic device having a camera and capable of participating in video conferencing sessions. The electronic device 100 may include a controller 102 (e.g., a central processing unit (CPU), a microprocessor, etc.), a storage 104 (e.g., random access memory (RAM), read-only memory (ROM)), an image sensor 106 (e.g., a camera) to capture images and video in an environment of the electronic device 100, a microphone 108 to capture audio in an environment of the electronic device 100, and a network interface 110. The network interface 110 enables the controller 102, the image sensor 106, and/or the microphone 108 to communicate with other electronic devices external to the electronic device 100. For example, the network interface 110 enables the controller 102 to transmit signals to and receive signals from another electronic device over the Internet, a local network, etc., such as during a video conferencing session. A bus 112 may couple the controller 102, storage 104, image sensor 106, microphone 108, and network interface 110 to each other. Storage 104 may store executable code 114 (e.g., an operating system (OS)) and executable code 114 (e.g., an application, such as a video conferencing application that facilitates video conferencing sessions with electronic devices via the network interface 110). In examples, the image sensor 106 may capture and store images and/or video (which is a consecutive series of images, or image frames) to the storage 104. In examples, the microphone 108 may capture and store audio to the storage 104. In examples, the storage 104 includes buffers (not shown) to temporarily store image and/or video captured by the image sensor 106 and/or audio captured by the microphone 108 prior to transmission via the network interface 110 or manipulation by the controller 102.

In operation, the controller 102 executes the executable code 114 to participate in a video conferencing session. As the controller 102 executes the executable code 114, the controller 102 receives images and/or video captured by the image sensor 106 and/or audio captured by the microphone 108 and provides the image, video, and/or audio data to the network interface 110 for transmission to another electronic device that is participating in the video conferencing session with the electronic device 100. As a component of participating in the video conferencing session, executing the executable code 114 may cause the controller 102 to execute or otherwise implement a CNN, such as to perform image segmentation as described herein to facilitate image background modification replacement in real-time or near real-time. In some examples, real-time or near real-time, includes a delay that is imperceptible to a user, during which processing may be performed.

As described above, a user of the electronic device 100 may be participating in the video conferencing session and may wish to alter a background of the video conferencing session. To perform such alteration, image segmentation is performed to separate a foreground subject of the video conferencing session from the background of the video conferencing session. The segmentation may be performed via a CNN having a U-shaped encoder-decoder architecture, as described herein. Based on the segmentation, the controller 102 modifies the background of the video conferencing session, such as by altering a portion of video of the video conferencing session (via blurring or image replacement) identified via the segmentation to be the background (or, alternatively, to not be the foreground).

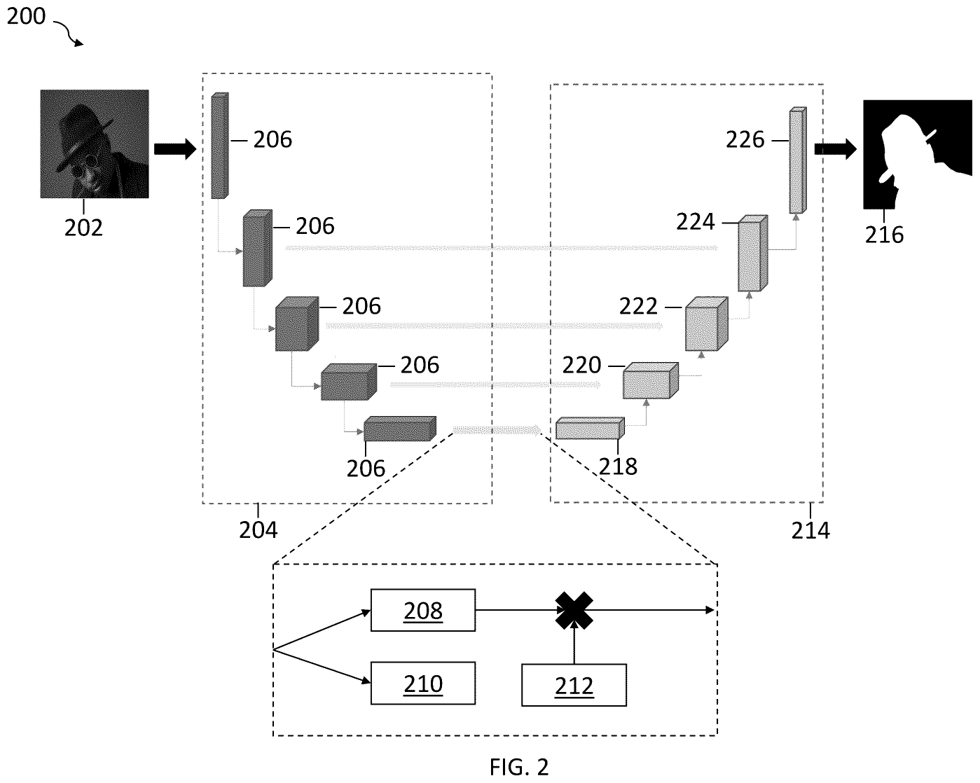

FIG. 2 is a diagram of a U-shaped encoder-decoder architecture 200, in accordance with various examples. In at least some examples, the controller 102 implements the architecture 200 to perform image segmentation, as described herein.

To perform the image segmentation, the controller 102 receives an image and resizes the image to provide a resized image 202. The resizing reduces a size of the image to a programmed size. The programmed size may be a size determined to have a sufficient balance between computational intensity, computational latency, and output accuracy, and may vary based on an application environment of the electronic device 100 and environment in which a result of the image segmentation will be used (e.g., low bandwidth streaming, high-bandwidth streaming, television broadcast, recording, etc.). In some examples, the programmed size is 224 pixels in height and 224 pixels in width. In other examples, any suitable size, or aspect ratio determined to have a sufficient balance between computational intensity, computational latency, and output accuracy is possible.

The resized image 202 may be encoded via an encoder 204 operating according to any suitable process to obtain a feature map. In an example, that process is a CNN encoding process, such as included in MobileNetV3, its successors, or similar processes. The feature map may include identified features of the resized image. For example, the feature map may include multiple channels, each having a same size as the resized image and each including one of the identified features. In some examples, the encoding includes multiple convolutional layers 206 with an output size of each layer 206 reducing, such as by one-half, with respect to the previous layer 206. For example, the encoding may include 5 layers 206 such that a result of the encoding, and output of the encoder 204, is a feature map having a size of 14 pixels height and 14 pixels width, with 960 channels (e.g., 960 identified features).

After obtaining the feature map, the controller 102 processes the feature map according to LR-ASPP, for instance. For example, the feature map is processed according to a convolutional layer 208 and a global average pooling layer 210. In an example, the global average pooling layer 210 applies an averaging processing for all pixels across all channels of the feature map. The convolutional layer 208 processes or manipulates the feature map by performing a 1×1 convolution on the feature map to reduce a number of channels of the feature map, normalizing the feature map via bath normalization, and performing ReLU activation, as described above. In an example, a number of channels included in an output of the convolutional layer 208 is equal to a number of filters according to which the 1×1 convolution was performed. In some examples, the output of the convolutional layer 208 includes 120 channels.

An output of the global average pooling layer 210 is provided to a convolutional layer 212. The convolutional layer 212 processes or manipulates the output of the global average pooling layer 210 by performing a 1×1 convolution on the reduce a number of channels of the output of the global average pooling layer 210, normalizing the output of the global average pooling layer 210, and performing Sigmoid activation, as described above, to normalize and weight a relative importance of the channels. Outputs of the convolutional layer 208 and convolutional layer 212 are multiplied with each other to form a LR-ASPP output. The LR-ASPP output is decoded via the decoder 214 to provide an segmentation result 216. In some examples, the decoder 214 includes layers 218, 220, 222, 224, and 226.

For example, at layer 218, the LR-ASPP output undergoes a first 3×3 convolution, batch normalization, and ReLU activation having a same number of input and output channels, followed by a second 3×3 convolution, batch normalization, and ReLU activation having a lesser number of output channels than input channels to form an output of layer 218. At layer 220, the output of layer 218 is concatenated with an output of a fourth layer of the encoder 204 (e.g., a skip connection). A result of the concatenation undergoes a first 3×3 convolution, batch normalization, and ReLU activation having a same number of input and output channels, followed by a second 3×3 convolution, batch normalization, and ReLU activation having a lesser number of output channels than input channels to form an output of layer 220. At layer 222, the output of layer 220 is concatenated with an output of a third layer of the encoder 204 (e.g., a skip connection). A result of the concatenation undergoes a first 3×3 convolution, batch normalization, and ReLU activation having a same number of input and output channels, followed by a second 3×3 convolution, batch normalization, and ReLU activation having a lesser number of output channels than input channels to form an output of layer 222. At layer 224, the output of layer 222 is concatenated with an output of a second layer of the encoder 204 (e.g., a skip connection). A result of the concatenation undergoes a first 3×3 convolution, batch normalization, and ReLU activation having a same number of input and output channels, followed by a second 3×3 convolution, batch normalization, and ReLU activation having a lesser number of output channels than input channels to form an output of layer 224. At layer 226, the output of layer 224 undergoes a first 3×3 convolution, batch normalization, and ReLU activation having a same number of input and output channels, followed by a second 3×3 convolution, batch normalization, and ReLU activation to provide the segmentation result 216 having 2 channels—a first channel representing an area of the input image 202 determined to be the foreground and a second channel representing an area of the input image 202 determined to be the background.

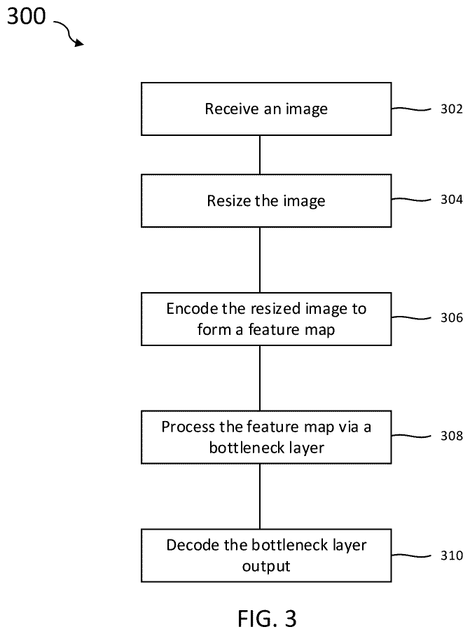

FIG. 3 is a flow diagram of a method 300 in accordance with various examples. In some examples, the method 300 is implemented by the controller 102, such as to perform image segmentation, as described herein. The controller 102 may perform or execute the method 300 as a result of executing the executable code 114, for example. The method 300 includes receiving an image (302) and resizing the image (304). The resizing may be to any programmed size or aspect ratio (e.g., via cropping) determined to be suitable for an application environment in which the image is used, as described above. The method 300 also includes encoding the resized image to form a feature map (306). The feature map may have a same size as the resized image and includes multiple channels, where each channel includes one unique feature of the features of the resized image identified via the encoding. The method 300 also includes processing the feature map via a bottleneck layer (308). Generally, processing via the bottleneck layer produces an output having a reduced dimensionality with respect to the feature map. The reduced dimensionality may be achieved, in an example, via one or more 1×1 convolutions. In an example, processing via the bottleneck layer includes processing performed by the layers 208, 210, and 212, with a final multiplication of outputs of the layers 208 and 212 to provide a bottleneck layer output, as described above with respect to FIG. 2. The method 300 also includes decoding the bottleneck layer output (310). In examples, the decoding is performed as described above with respect to the decoder 214 of FIG. 2, incorporating data provided via skip connections from the encoder 204. The decoding is performed to, for example, obtain an image segmentation result, as described above herein.

The method 300 is implemented by machine-readable instructions (e.g., the executable code 114) stored to a storage device (e.g., the storage device 104) of an electronic device (e.g., the electronic device 100), in various examples. A processor (e.g., the controller 102) of the electronic device executes the machine-readable instructions to perform the method 300, for example. Unless infeasible, some or all of the method 300 may be performed concurrently or in different sequences. For example, the processor performs a block that occurs responsive to a command sequential to the block describing the command. In another example, the processor performs a block that depends upon a state of a component after the state of the component is enabled or disabled.

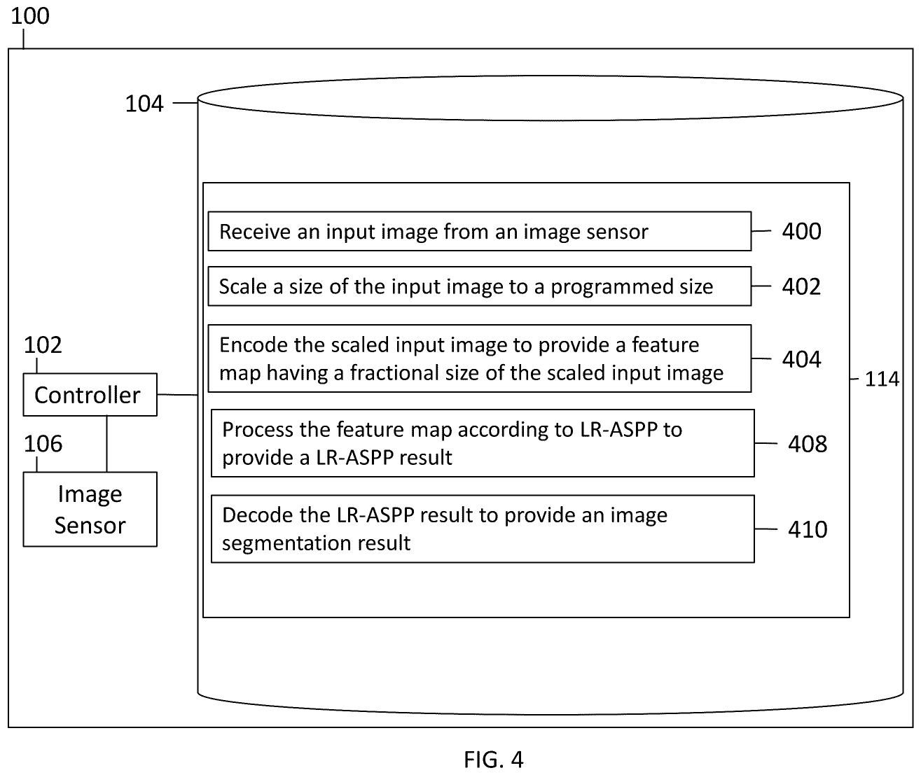

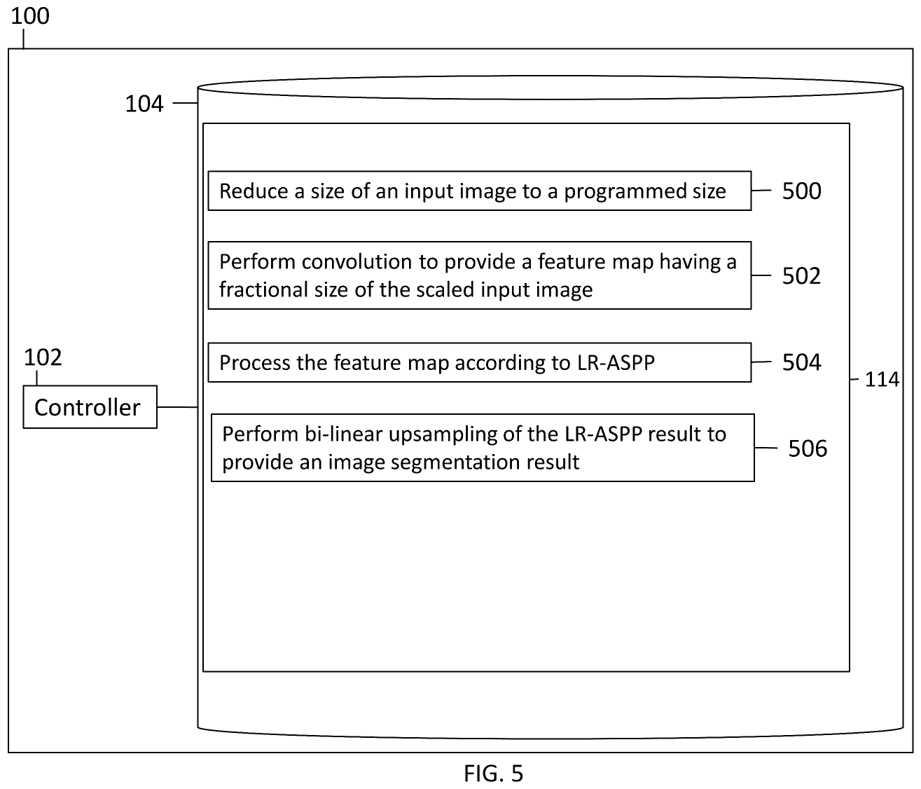

FIGS. 4 and 5 are block diagrams of the electronic device 100, including the controller 102 coupled to the storage 104, in accordance with various examples. Specifically, FIG. 4 shows an example of the electronic device 100, including the controller 102 coupled to the storage 104 along with image sensor 106 coupled to the controller 102. The storage 104 stores executable instructions (e.g., such as part of the executable code 114) that may be executed by the controller 102. The storage 104 includes executable instruction 400, which causes the controller 102 to receive an input image. The storage 104 includes executable instruction 402, which causes the controller 102 scale a size of the input image to a programmed size. The storage 104 includes executable instruction 404, which causes the controller 102 encode the scaled input image to provide a feature map having a fractional size of the scaled input image. The storage 104 includes executable instruction 406, which causes the controller 102 to process the feature map according to LR-ASPP to provide a LR-ASPP result. The storage 104 includes executable instruction 408, which causes the controller 102 to decode the LR-ASPP result to provide an image segmentation result. In examples, the controller 102 performs operations or functions as described above herein in executing the instructions 400, 402, 404, 406, 408 to provide the image segmentation result.

FIG. 5 shows an example of the electronic device 100, including the controller 102 coupled to the storage 104. The storage 104 stores executable instructions (e.g., such as part of the executable code 114) that may be executed by the controller 102 to implement an image segmentation process. The storage 104 includes executable instruction 500, which causes the controller 102 to reduce a size of an input image to a programmed size. The storage 104 includes executable instruction 502, which causes the controller 102 to perform convolution to provide a feature map having a fractional size of the scaled input image. The storage 104 includes executable instruction 504, which causes the controller 102 to process the feature map according to LR-ASPP to provide a LR-ASPP result. The storage 104 includes executable instruction 504, which causes the controller 102 to perform bi-linear upsampling of the LR-ASPP result to provide an image segmentation result. In examples, the controller 102 performs operations or functions as described above herein in executing the instructions 500, 502, 504, 506 to provide the image segmentation result.

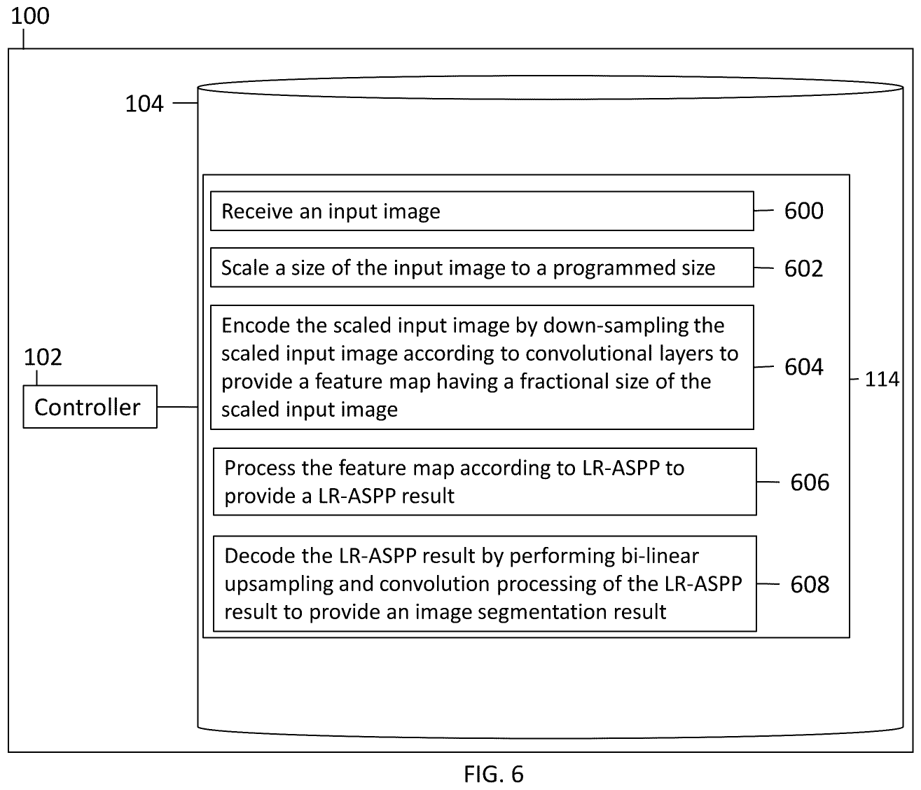

FIG. 6 is a block diagram of non-transitory, computer-readable media in accordance with various examples. Specifically, FIG. 6 depicts an example of the electronic device 100, including the controller 102 coupled to the storage 104. The storage 104 stores executable instructions (e.g., such as part of the executable code 114) that may be executed by the controller 102. The storage 104 includes executable instruction 600, which causes the controller 102 to receive an input image. The storage 104 includes executable instruction 602, which causes the controller 102 to scale a size of the input image to a programmed size. The storage 104 includes executable instruction 604, which causes the controller 102 to encode the scaled input image by down-sampling the scaled input image according to convolutional layers to provide a feature map having a fractional size of the scaled input image. The storage 104 includes executable instruction 606, which causes the controller 102 to process the feature map according to LR-ASPP to provide a LR-ASPP result. The storage 104 includes executable instruction 608, which causes the controller 102 to decode the LR-ASPP result by performing bi-linear upsampling and convolution processing of the LR-ASPP result to provide an image segmentation result. In examples, the controller 102 performs operations or functions as described above herein in executing the instructions 600, 602, 604, 606, 608 to provide the image segmentation result.

As described herein, executable code includes an “application,” “software,” and “firmware. The terms “application,” “software,” and “firmware” are considered to be interchangeable in the context of the examples provided. “Firmware” is considered to be machine-readable instructions that a processor of the electronic device executes prior to execution of the operating system (OS) of the electronic device, with a small portion that continues after the OS bootloader executes (e.g., a callback procedure). “Application” and “software” are considered broader terms than “firmware,” and refer to machine-readable instructions that execute after the OS bootloader starts, through OS runtime, and until the electronic device shuts down.

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein are shown in exaggerated scale or in somewhat schematic form, and some details of certain elements are not shown in the interest of clarity and conciseness. In some of the figures, in order to improve clarity and conciseness, a component or an aspect of a component is omitted.

In the above description and in the claims, the term “comprising” is used in an open-ended fashion, and thus should be interpreted to mean “including, but not limited to . . . .” Also, the term “couple” or “couples” is intended to be broad enough to encompass both direct and indirect connections. Thus, if a first device couples to a second device, that connection may be through a direct connection or through an indirect connection via other devices, components, and connections. Additionally, the word “or” is used in an inclusive manner. For example, “A or B” means any of the following: “A” alone, “B” alone, or both “A” and “B.”

What is claimed is:

1. An electronic device, comprising:
a processor to:
receive an input image from an image sensor;
scale a size of the input image to a programmed size;
encode the scaled input image to provide a feature map having a fractional size of the scaled input image;
process the feature map according to lite reduced atrous spatial pyramid pooling (LR-ASPP) to provide a LR-ASPP result; and
decode the LR-ASPP result to provide an image segmentation result.

2. The electronic device of claim 1, wherein providing the LR-ASPP result includes parallel processing paths, a first of the processing paths including a first convolutional layer and a second of the processing paths including a pooling layer and a second convolutional layer.

3. The electronic device of claim 2, wherein an output of the first of the processing paths and an output of the second of the processing paths are multiplied to form the LR-ASPP result.

4. The electronic device of claim 2, wherein the first convolutional layer includes a first convolution operation to reduce dimensionality of the feature map, a normalization operation, and a Rectified Linear Unit (ReLU) activation operation, wherein the pooling layer performs global average pooling based on the feature map, and wherein the second convolutional layer includes a second convolution operation to reduce dimensionality of an output of the pooling layer, and a Sigmoid activation operation.

5. The electronic device of claim 1, wherein the encoding includes multiple encoding layers and the decoding includes multiple decoding layers, and wherein outputs of at least some of the encoding layers are concatenated with outputs of at least some of the decoding layers to form an input to a subsequent on of the decoding layers.

6. An electronic device, comprising:
a processor to implement an image segmentation process to:
reduce a size of an input image to a programmed size;
perform convolution to provide a feature map having a fractional size of the scaled input image;
process the feature map according to lite reduced atrous spatial pyramid pooling (LR-ASPP) to provide a LR-ASPP result; and
perform bi-linear upsampling of the LR-ASPP result to provide an image segmentation result.

7. The electronic device of claim 6, wherein the input image includes a first number of channels, the feature map includes a second number of channels greater than the first number of channels, and the image segmentation result includes two channels.

8. The electronic device of claim 6, wherein the bi-linear upsampling includes convolution to reduce dimensionality of the LR-ASPP result.

9. The electronic device of claim 8, wherein the bi-linear upsampling incorporates skip connection outputs of the encoding.

10. The electronic device of claim 6, wherein the LR-ASPP processing reduces dimensionality of the feature map to form the LR-ASPP result.

11. A non-transitory computer-readable medium storing machine-readable instructions which, when executed by a controller of an electronic device, cause the controller to:
receive an input image;
scale a size of the input image to a programmed size;
encode the scaled input image by down-sampling the scaled input image according to convolutional layers to provide a feature map having a fractional size of the scaled input image;
process the feature map according to lite reduced atrous spatial pyramid pooling (LR-ASPP) to provide a LR-ASPP result; and
decode the LR-ASPP result by performing bi-linear upsampling and convolution processing of the LR-ASPP result to provide an image segmentation result.

12. The computer-readable medium of claim 11, wherein the image segmentation result identifies a foreground and a background of the scaled input image.

13. The computer-readable medium of claim 12, wherein the instructions, when executed by the controller, further cause the controller to manipulate the background of the scaled input image based on the image segmentation result.

14. The computer-readable medium of claim 11, wherein decoding the LR-ASPP result also includes convolution to reduce dimensionality of the LR-ASPP result to form the image segmentation result and concatenation with outputs of the encoding provided via skip connections.

15. The computer-readable medium of claim 14 wherein the input image includes a first number of channels, the feature map includes a second number of channels greater than the first number of channels, and the image segmentation result includes two channels.
